(19) United States
(12) Patent Application Publication
(10) Pub. No.: US 2002/0069100 A1
(43) Pub. Date: Jun. 6, 2002

(54) System and method for content recognition over the internet

(76) Inventor: Joel Arberman, Atlanta, GA (US)

Correspondence Address: Walter G. Hanchuk, MORGAN & FINNEGAN, L.L.P, 345 Park Avenue, New York, NY, 10154, US

(21) Appl. No.: 09/728,353

(22) Filed: Dec. 1, 2000

Related U.S. Application Data
(60) Provisional application No. 60/168,347, filed on Dec. 1, 1999.

(51) Int. Cl. G06F 17/60

(52) U.S. Cl. 705/10

(57) ABSTRACT

A system and method for recognizing content used, searched and transmitted by user, while the user in online or offline. The method includes collecting information from one or more business partners. The collected information is organized into distinct sections or categories. A user sends a request for access to information on one or more selected topics, and in response the system makes available information on the selected topic to the user. Statistics are updated and maintained on user usage to reflect the access information.

### BACKGROUND OF THE INVENTION

1. Field of the Invention

This invention relates to a method and system for content recognition over the Internet, and more particularly to a method and system for recognizing, receiving and transmitting the desired content over the Internet.

2. Description of Related Art

As the popularity in usage of the Internet increases, so does the amount of information available on the Internet. The information that exists on the World-Wide Web (WWW) is of many different types, which can be categorized as documents, computer software, electronic journals, online information services, databases, campus wide information server computers (CWIS), library catalogues, mailing lists, discussion lists, and news groups. Additionally, the information may relate to a diverse segment of people having various different interests.

With the ready availability of computers, usage and reliance on electronic information has become an ordinary fact of life. Furthermore, it is also becoming common to use the Internet and/or the Intranet to research and search for content that ordinarily was obtained only by manual searching in the libraries. With computer usage becoming increasingly common, more and more information is being collected, electronically stored and transferred over the Internet.

Fortunately for users, most of the information on the Internet can be accessed though the WWW using a browser, which is a software program allowing one to navigate the network in a user-friendly way. The user is merely required to provide a Uniform Resource Locator (URL) address for the desired web page, and the browser then launches the underlying web site for which the address is provided. Unfortunately, it is rare for users to know the precise URL addresses of all the web pages that may be of interest. Even if one is able to remember URL addresses, the rapid changes to the WWW often make the URL addresses obsolete, requiring new and updated ones.

The explosion of information on the Internet has led to a vast amount of data being generated on the WWW. Server computers and web pages continue to mushroom at an ever-increasing speed. This presents a problem in identifying and remembering the web pages of interest to a user. Where the user does not know the server computer name of a web page, generally he or she may use search engines to surf the net to identify the appropriate web page.

While search engines are capable of providing users with various bits and pieces of information that satisfy one's search criteria, these existing search engines are incapable of providing users with information customized to their own individualized needs. Furthermore, existing searching and browsing mechanisms require the users to actively access the Internet and search for the desired information they need. Finally, existing software are also incapable of studying a user's interests and providing the user with a selection of Internet web sites that conform the user's tastes, needs, desires or preferences.

Because of all these disadvantages, there is a need for a system which allows individuals to receive customized information from the Internet, based on the individuals' interests, usage and the like.

### SUMMARY OF THE INVENTION

The present invention overcomes the above-mentioned disadvantages. According to one aspect, content recognition software, resident on the users' personal computer, facilitates the users in receiving content/information based on the user's browsing habits and preferences.

According to the invention, content is collected form a variety of sources, and the content is dynamically and/or manually inserted, categorized and stored in server. Users register their content recognition software and enter their profile and selection of interests, which is sent to the server. The content recognition software runs an algorithm on a data CD inserted into the users' CD-ROM player, and the results are sent to the server.

The server is able to identify the CD based on the underlying algorithms by matching the result with a database containing such information, and logs a variety of data about the user, usage, and the like. Next, the server pushes information relevant to the user, which may include CD-specific content as well as other related items, such as advertisement and commerce opportunities. The user can select from the available content, and all of user's interactions are stored on the server. If the user is not connected to Internet then all of user's interactions and usage information is stored on the personal computer and later transmitted to the server upon next connection to the Internet.

All data presented by server is customized to the user based on analysis of current actions, prior actions and anticipated actions. The analysis uses all information entered by user as well as all data captured by system. This data may also be analyzed and mined for patterns, behaviors and usage so that information can be packaged and sold to commercial partners.

### BRIEF DESCRIPTION OF THE DRAWINGS

FIG. 1A is a schematic block diagram depicting the system of one embodiment of the present invention;

FIG. 1B is a schematic block diagram depicting the system of another embodiment of the present invention;

FIG. 2 is a schematic block diagram depicting the system linking to a web site of a third-party merchant;

FIG. 3 is a schematic flow diagram depicting the steps for collecting information from affiliated members and transmitting relevant information to users; and

FIG. 4 is a schematic flow diagram depicting the steps for launching and using the content recognition software of the present invention.

### DETAILED DESCRIPTION

The present invention relates to a system and method for recognizing content indistinguishable to a PC, and receiving and transmitting relevant content desired by a user over the Internet. According to one embodiment, the system comprises a desktop software that enables the collection of user preference information that may be utilized in the form of a full cross industry (channel) portal. Depending on the industry for which the present invention is to be used and the most effective way of collecting information from the industry's customer group, the desktop portal facilitates the collection of user information and makes content, services and/or products from one or more vendors and/or other strategic partners available to the users of the service.

For example, for its use in the music or video games industries, the present invention utilizes a unique Compact Disk (CD) reading software to identify users preferences and build user profiles from that information. As another example, for the invention's use in the healthcare industry, collection of information on the type of content most frequently accessed and/or requested by a user or users will be used to build profiles of users' searching and browsing habits. In addition, assuming the portal is utilized across multiple industry channels, a lifestyle user profile can be built to generate unique sets of content, service and product offerings for different groups of users.

The server software can perform unique segmentation functions that are based on the constant and diverse information reservoir that is created from the explicit and implicit interactions of users via their personal computers, which interact with a central server. The segmentation is performed intuitively and dynamically on the server, which is automatically populated with user data by one or more data collection mechanisms (such as the CD-ROM reader) and user clicks. The segmentation of the aggregated information is collected in the server to further enhance the future delivery of information to users.

The present invention allows service providers to act as middlemen and/or in a conduit role that is unprecedented within each channel as well as across each channel in creating uniquely targeted lifestyle suites of content, services and products direct to the user desktop. The users are provided on-line as well as off-line access to the information provided by the service providers. The desktop portal has a graphical user interface (GUI) layer that is organized by channel, and users may choose to access as many channels as the service provider offers. The more channels a user chooses, the richer the user's experience could be.

Beneath the GUI layer is the information layer that comprises the content, products and services identified for and by the user to access. In addition, there is a data collection mechanism layer that comprises the CD-ROM reader and expert system driven modules that are designed to capture and transmit user computer interactions. On the server, the GUI layer, information layer and the data collection mechanism layer combine together to generate the user profile/segmentation layer of the service provider system.

According to another aspect, content is collected form a variety of sources, and the content is dynamically and/or manually inserted, categorized and stored in server. Users register their content recognition software and enter their profile and selection of interests into the GUI layer of the content recognition software, which is sent to the server. The content recognition software runs an algorithm on every data CD inserted into the users' CD-ROM player, and the results are sent to the server, which allows the server to recognize each registered user. The server identifies each CD and logs a variety of data about the user, usage, and the like.

The server transmits information relevant to the user, which may include CD-specific content as well as other related items, such as advertisement and commerce opportunities. The user can select from the available content, and all of the user's interactions are sent to and stored on the server. If the user is not connected to the Internet then all of the user's interactions and usage information is stored on the personal computer and later transmitted to the server upon next connection to the Internet. The data presented by the server is customized to the user based on analysis of current actions, prior actions and anticipated actions. The analysis uses all information entered by user as well as all data captured by system.

With reference to the figures, various embodiments of the present invention will now be described in greater detail. It is to be understood that the tasks shown in the figures and described in this description can be sequenced in many different orders to achieve the desired result. The order or sequence of tasks illustrated in the figures is merely intended to be exemplary of the concepts defined herein.

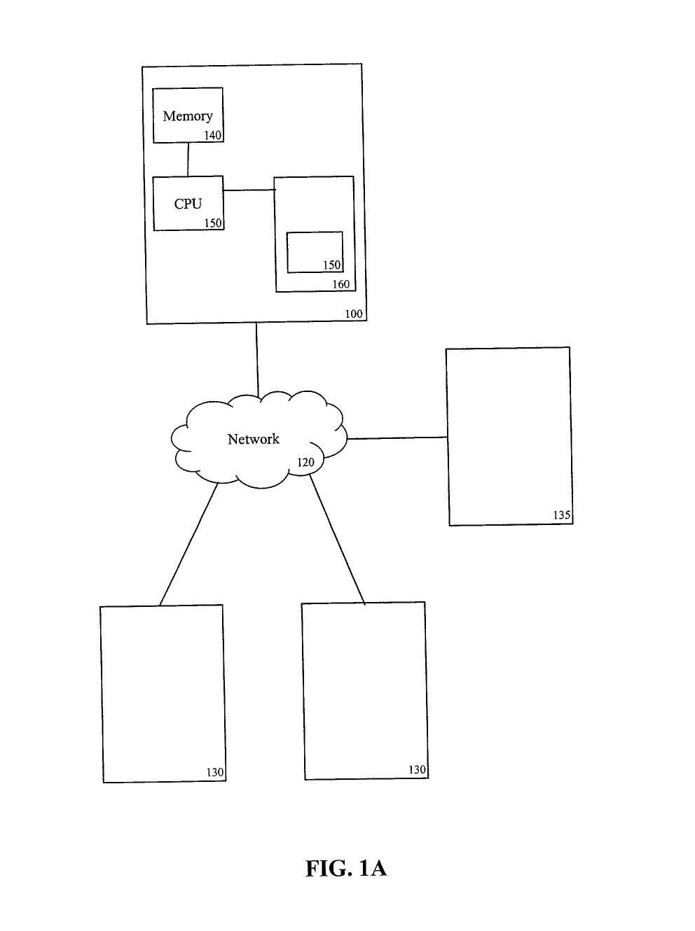

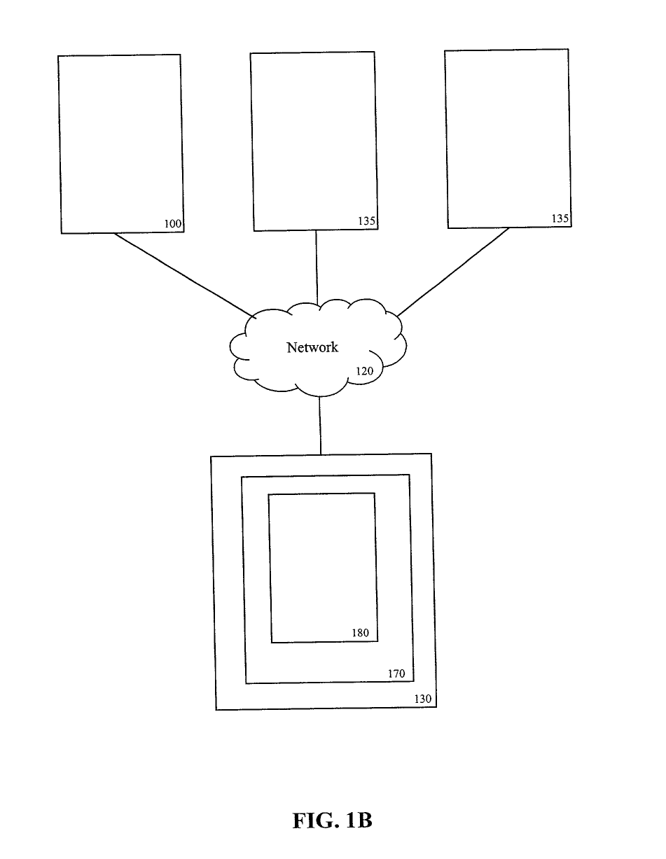

FIGS. 1A-1B provide an illustration of the system in accordance with the present invention. The invention comprises a computerized method and system for recognizing content used by one or more users, wherein users use a client program to connect to the server to browse, access and retrieve information and/or other content.

Shown in the FIG. 1A is a central server 100 that forms the backbone of the present invention. The server 100 is accessible over a network 120 by one or more users 130. The users' systems are generally termed as clients. The users may connect to the server 100 over the network 120 by dialing in, using a simple telephone line, an Integrated Services Digital Network (ISDN) line, a cable modem line, an electronic data link, optical fiber connection, wireless data connection or any other known connection used for data transfer over the Internet or an Intranet. Alternatively, the client/server architecture of the electronic folder management system can be designed as a Local Area Network (LAN), a Wide Area Network (WAN) or the like. Depending upon the implementation, the connections can provide one or more modes of transmission, such as radio frequency transmissions, optical transmission, microwave transmission, digital or analog transmission, or other known data transmission. According to the invention, the user 130 may also connect to one or more web sites 135 for accessing information hosted thereby.

The server 100 comprises a memory unit 140 and a central processing unit (CPU) 150. The memory unit 140 serves as the electronic holding place for instructions and data that the CPU 150 can reach quickly for processing. The CPU 140 is the central unit in the server 100 containing logic circuitry that performs the instructions of resident programs that drive the server 100. It should be noted that the server 100 is not limited in its form, and may be a network of computers, a distributed system, a mainframe computer, a web site and other related computer systems implementations or formats. It should be noted that many different configurations of a server 100 are contemplated as being within the spirit of the present invention.

The CPU 150 is connected to a storage unit 160 by a bus. Storage 160 contains a database 165, which is configured to store information accessed and/or requested by a user as well as information that was not accessed and/or requested by the user to build profiles of users' searching and browsing habits. In addition, the database 165 is utilized to store information regarding different content, service and product offerings that are offered to different groups of users. The storage unit 160 is not limited in its form, and may be a hard disk, a floppy disk, a CD-ROM, or a tape backup system.

The server 100 may be provided with one or more connection means for connecting to the network 120. The scope of the present invention is not limited by the choice of connection means employed. Accordingly, it is possible to use a modem, a DSL system, an ISDN system, a cable modem or any similar device to allow a remote user 130 to connect with the server 100.

As shown in FIG. 1B, the client 130 comprises content recognition software 170, which includes a desktop portal 180 that can be used to interact with the Internet. The desktop portal 180 may be used to connect to a server that houses the server 100, or to a plurality of non-service provider web sites 135 to search and access the information desired by the user 135. Where the user connects to the server 100 for information, the CPU 150 processes the activities of the clients connecting thereto. It should be noted that the desktop portal 180 can be customized based on users' needs and/or commercial applications.

The user's content recognition software 180 comprises a GUI layer, information layer and the data collection mechanism layer. According to one embodiment, the GUI layer forms a part of the desktop portal 180. The user is able to provide his or her selection of subjects for which information is sought using the GUI layer, and the content recognition software 170 will guide the user to appropriate web sites that provide information relating to the sought subjects or topics. In addition, the content recognition software 170 monitors and records the user's searching and browsing habits. Anytime the user connects to the network 120, the content recognition software 170 automatically transfers the recorded information on the users' searching and browsing habits to the server 100 which is recorded in the database 165. The service provider uses the information in the database 165 to provide better customize the information that is fed to the users.

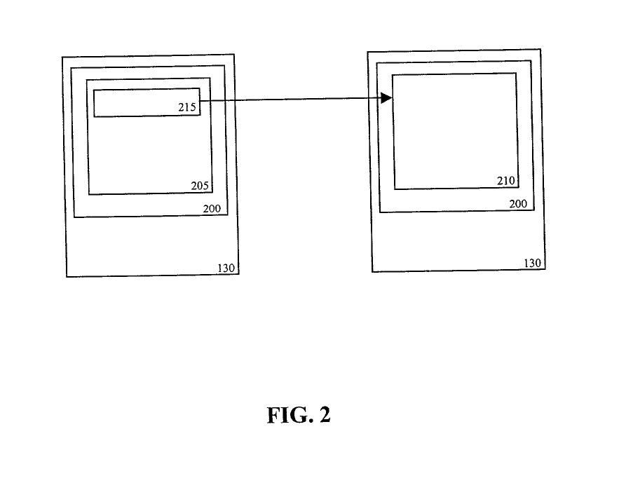

According to another embodiment, as shown in FIG. 2, a user 130 may use a browser 200 to access a first web site 205. The first web site 205 may belong to any third party or to the service provider, but which is sponsored, controlled, hosted or monitored by the service provider. According to one embodiment, the first web site 205 may comprise a library of different sections, wherein each section has a plurality of URLs or links 215 for a variety of different but related sites that provide information related to or on the underlying subject. A user may choose a particular section, and then choose the URL 215 for the web site that he or she decides to browse to for viewing and reviewing the material listed therein. The URLs 215 point to other third party web sites 210.

When a user clicks on the URL 215, the user is transferred to the third party web site 210 that is hosted at the URL addressed by the clicked link 215. The third party whose web site is addressed by the link 215 may be a sponsor or a merchant affiliated with the service provider. The user may be provided with more related links or URLs from the third party web site 215 for other related web sites. According to the invention, anytime a user clicks on a URL that is sponsored, managed or monitored by the service provider, any and all related information pertaining to the browsing by the user is transmitted to the service provider's database 165.

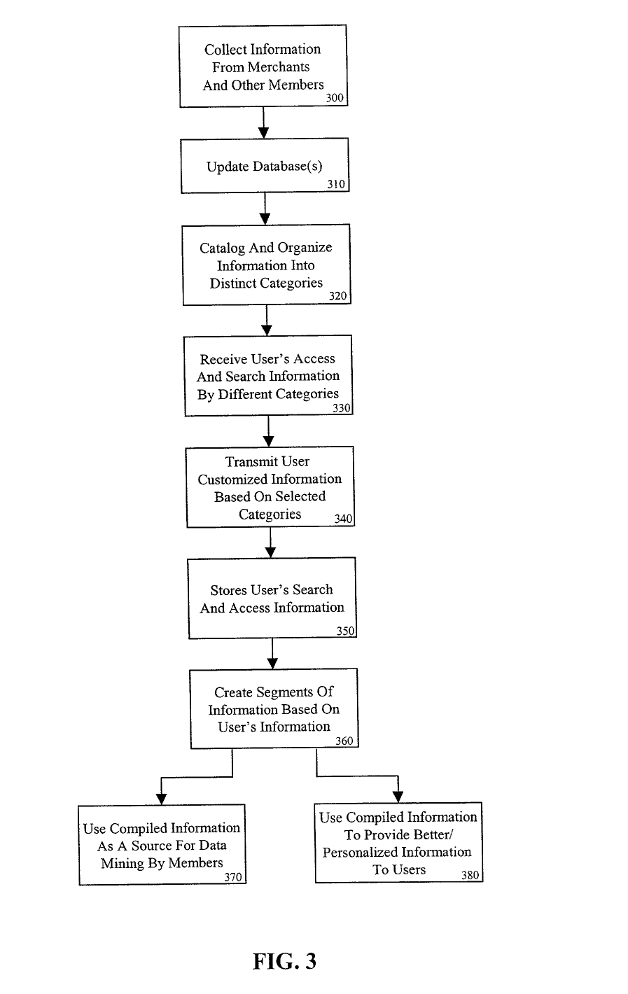

FIG. 3 provides an illustration of the process for collecting information and/or data from affiliated merchants and/or other third parties and then allowing users the ability to access the collected information. At step 300, the service provider collects data, web site URLs belonging to third parties, or any other related information that may be of interest to the browsing public from merchants and/or other entities that wish to affiliate with the service provider. Generally, the affiliated entities will register with the service provider to have their information and or advertisements viewed by the users 130. This collected information is used to update the service provider's database of information, in step 310. In step 320, the service provider organizes the collected information. The collected information is cataloged and organized under distinct and appropriate sections.

In step 330, the service provider receives access request from a user. The user's access request may be a simple search request or an explicit request to access any particular web site designated by a given URL. Alternately, the user may merely provide one or more sections to which he or she desires access. The request may be provided by a user when the user is online. In step 340, the service provider transmits the information to the user. The transmitted information may either be a simple result to the search request, or a complete index of URLs within the sections desired and requested by the user.

In step 350, the server 100 updates its own database 165 with the user's request, the transmitted information in response to the request, and all other information that may be used to compile statistics about users' usage behavior. Since some users may prefer to obtain information from a variety of different sections or topics, wherein the topics may or may not be related, the service provider can use the collected information to data mine for creating users' use profiles and behaviors. This data may also be analyzed and mined for patterns, behaviors and usage so that information can be packaged and sold to commercial partners. As a result, in step 360, the service provider data mines the collected information and segments its collection of URLs and other Internet-accessible information in a user-friendly manner.

In step 370, the service provider provides all the collected and organized information as a source for data mining by its affiliated merchants and/or members. The affiliated members and merchants make use the user profiles to conduct surveys, streamline their web sites to accommodate users' browsing references, provide users with customized Internet-based advertisements, or the like. Alternately, or in addition to allowing access to affiliated merchants, the service provider may also use the collected information to provide better, more personalized and/or customized information to users, in step 380. For example, where the users show a preference for accessing information on sexual health more often than accessing information on coronary diseases, the users may be provided with a larger selection of articles and/or other information of sexual health when the users request information on a health-related topic.

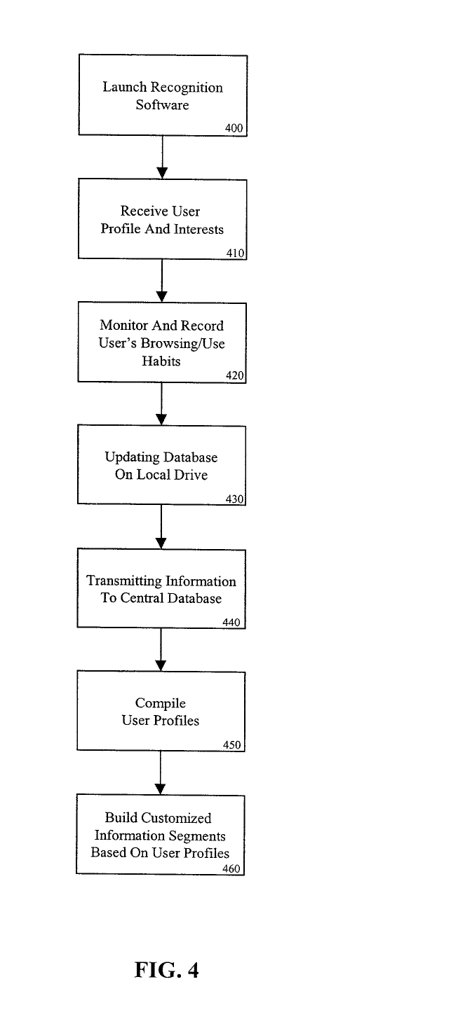

FIG. 4 provides an illustration of the launching and use of the content recognition software 180 by the user. In step 400, the content recognition software 180 is launched. The content recognition software 180 may be manually launched by a user or automatically launched by the user's PC when the PC is booted up, or automatically launched when a data CD is inserted into a CD-ROM player. In step 410, the content recognition software 180 receives the user's profile, interests, and/or selection of sections that the user wishes to access from the service provider. To enable the user in inputting his or her information, the content recognition software 180 has a GUI that guides the user through the input phase. Access to sections may be based on a paid subscription fee or free for all.

In step 420, the content recognition software 180 monitors the user's searching and browsing habits. In step 430, the content recognition software 180 updates a local database to accurately reflect the user's searching and browsing habits and maintain appropriate statistics thereof. The information is collected using a data collection mechanism, which is part of the data collection layer of the content recognition software 180. The data collection mechanism layer comprises a CD-ROM reader and expert system driven modules that are designed to observe user computer interactions. In step 440, the content recognition software 180 transmits the information collected from the user to the server 100 that belongs to the service provider.

In step 450, the service provider compiles the collected information and statistics and appropriately stores its results. These results can be used to data mine for creating users' use profiles and behaviors. The collected information is segmented into a collection of URLs and other Internet-accessible information in a user-friendly manner, in step 460.

The collected and organized information may be used as a source for data mining by merchants and/or other members affiliated with the service provider. In addition, the service provider may also use the collected information to provide better, more personalized and/or customized information to users.

According to another embodiment, the user may be provided with offline content recognition software that is resident only on a CD-ROM or the user's PC. The offline content recognition software comprises a content recognition component and a plurality of sections or libraries, where each section has a number of appropriate articles, information and/or other related and desired information listed thereunder. Each time the user accesses some information on CD-ROM or the PC, the content recognition component of the offline content recognition software monitors and records the users' usage patterns. Based on the user's usage habits, the offline content recognition software transmits other information and content to the user that is related to or similar to the content that the user actively selects and/or uses.

It is also possible that whenever the user connects to a network 120, the content recognition software transmits the users' usage statistics to the service provider's server 100, where the transmitted information is used in accordance with to the aforementioned discussion. According to another embodiment, the present invention automatically updates, augments and supplements the information in the plurality of sections that are a part of the offline content recognition software. As a result, when the user is offline, the user is always able to access recent information.

As is clear from the aforementioned discussion, the present invention can be used to facilitate a one-on-one connection between highly targeted and profiled customers and/or clients, on the one hand, and various third party marketers trying to reach these consumers on the other hand. The present invention allows users to obtain targeted, desired and useful information based on their needs and/or usage habits, whether they are online or offline. On the other hand, the present invention allows merchants and service providers to better target the information and advertisements they send to the user of the present invention.

It is understood that the above description is only representative of illustrative examples of embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Those skilled in the art will recognize that the method and system of the present invention has many applications, and that the present invention is not limited to the representative examples disclosed herein. Alternate embodiments may not have been presented for a specific portion of the invention. Some alternate embodiments may result from a different combination of described portions, or other undescribed alternate embodiments may be available for a portion. This is not to be considered a disclaimer of those alternate embodiments. It is recognized that many of those undescribed embodiments are within the literal scope of the following claims, and others are equivalent.

It is to be understood that the tasks described in the following claims can be sequenced in many different orders to achieve the desired result. Thus, the scope of the present invention covers conventionally known variations and modifications to the system components and the method steps described herein, as would be known by those skilled in the art.

What is claimed is:

1. A method for content recognition, comprising:
collecting information from one or more business partners;
organizing the collected information into distinct categories;
receiving a search request from a user;
transmitting information to the user in accordance with the search request; and
updating statistics on user usage to reflect the search request by the user.

2. The method of claim 1, further comprising creating segments of usage patterns, where said usage patterns are created based on the statistics on user usage by a plurality of users.

3. The method of claim 2, further comprising storing all information regarding the search request made by the user and the information transmitted to the user.

4. The method of claim 3, further comprising data mining the stored information to better customize the information being transmitted to the user.

5. The method of claim 4, further comprising transmitting non-requested information to the user, wherein the non-requested information is similar to the information transmitted to the user in response to the search request.

6. A method for content recognition, comprising:
collecting information from one or more business partners;
organizing the collected information into distinct categories;
receiving a request from a user to access information on a selected topic;
making available information on the selected topic to the user; and
updating statistics on user usage to reflect the access information.

7. The method of claim 6, wherein said access information comprises request for access to libraries of information on one or more topics.

8. The method of claim 7, further comprising creating segments of usage patterns, where said usage patterns are created based on the access information provided by a plurality of users.

9. The method of claim 8, further comprising storing the access information.

10. The method of claim 9, further comprising data mining the stored information to better customize the information being transmitted to the user.

11. The method of claim 10, further comprising transmitting non-requested information to the user, wherein the non-requested information is similar to the information transmitted to the user in response to the access information selected by the user.

12. A method for content recognition, comprising:
launching content recognition software on a personal computer;
receiving a user profile from a user;
transmitting the user profile and the list of interest to a server for data collection;
transmitting information to the user in accordance with the user profile and interests;
compiling statistics based on the user profile and the list of interests; and
creating a plurality of libraries on different topics, said libraries created based on the compiled statistics.

13. The method of claim 12, wherein the server develops a list of interests based on the user profile.

14. The method of claim 12, further comprising monitoring usage habits of the user.

15. The method of claim 14, further comprising collecting data on the usage habits of the users, said data collected by the content recognition software after said monitoring.

16. The method of claim 15, wherein the content recognition software comprises a data collection mechanism to collect said data on usage habits of the user.

17. The method of claim 16, wherein the server collects comprehensive data on the usage habits of a plurality of users.

18. The method of claim 17, further comprising data mining the comprehensive data in the server.

19. The method of claim 18, further comprising transmitting non-requested information to the user by the server, wherein the non-requested information is similar to the information transmitted to the user in response to the search request.

20. A system for content recognition, comprising:
a. a memory unit; and
b. a processing unit disposed in communication with said memory unit, said processing unit configured to:
collect information from one or more business partners,
organize the collected information into distinct categories,
receive a search request from a user,
transmit information to the user in accordance with the search request, and
update statistics on user usage to reflect the search request by the user.

21. The system of claim 20, wherein the processing unit is further configured to create segments of usage patterns, where said usage patterns are created based on the statistics on user usage by a plurality of users.

22. The system of claim 21, wherein the processing unit is further configured to store information regarding the search request made by the user and the information transmitted to the user.

23. The system of claim 22, wherein the processing unit is further configured to data mine the stored information to better customize the information being transmitted to the user.

24. The system of claim 23, wherein the processing unit is further configured to transmit non-requested information to the user, wherein the non-requested information is similar to the information transmitted to the user in response to the search request.

25. A system for content recognition, comprising:
a. a memory unit; and
b. a processing unit disposed in communication with said memory unit, said processing unit configured to:
collect information from one or more business partners,
organize the collected information into distinct categories,
receive a request from a user to access information on a selected topic,
make available information on the selected topic to the user, and
update statistics on user usage to reflect the access information.

26. The system of claim 25, wherein said access information comprises request for access to libraries of information on one or more topics.

27. The system of claim 26, wherein the processing unit is further configured to create segments of usage patterns, where said usage patterns are created based on the access information provided by a plurality of users.

28. The system of claim 27, wherein the processing unit is further configured to store the access information.

29. The system of claim 28, wherein the processing unit is further configured to data mine the stored information to better customize the information being transmitted to the user.

30. The system of claim 29, wherein the processing unit is further configured to transmit non-requested information to the user, wherein the non-requested information is similar to the information transmitted to the user in response to the access information selected by the user.

31. A system for content recognition, comprising:
a. a memory unit; and
b. a processing unit disposed in communication with said memory unit, said processing unit configured to:
launch content recognition software on a personal computer,
receive a user profile and a list of interests from a user,
transmit the user profile and the list of interest to a server for data collection,
transmit information to the user in accordance with the user profile and interests,
compile statistics based on the user profile and the list of interests, and
create a plurality of libraries on different topics, said libraries created based on the compiled statistics.

32. The system of claim 31, wherein the processing unit is further configured to monitor usage habits of the user.

33. The system of claim 32, wherein the processing unit is further configured to collect data on the usage habits of the users, said data collected by the content recognition software after said monitoring.

34. A system for content recognition, comprising:
means for collecting information from one or more business partners;
means for organizing the collected information into distinct categories;
means for receiving a search request from a user;
means for transmitting information to the user in accordance with the search request; and
means for updating statistics on user usage to reflect the search request by the user.

35. The method of claim 34, further comprising means for creating segments of usage patterns, where said usage patterns are created based on the statistics on user usage by a plurality of users.

36. A system for content recognition, comprising:
means for collecting information from one or more business partners;
means for organizing the collected information into distinct categories;
means for receiving a request from a user to access information on a selected topic;
means for making available information on the selected topic to the user; and
means for updating statistics on user usage to reflect the access information.

37. The system of claim 36, further comprising means for creating segments of usage patterns, where said usage patterns are created based on the access information provided by a plurality of users.

38. The system of claim 37, further comprising means for storing the access information.

39. The system of claim 38, further comprising means for data mining the stored information to better customize the information being transmitted to the user.

40. The system of claim 39, further comprising means for transmitting non-requested information to the user, wherein the non-requested information is similar to the information transmitted to the user in response to the access information selected by the user.

41. A system for content recognition, comprising:
means for launching content recognition software on a personal computer;
means for receiving a user profile and a list of interests from a user;
means for transmitting the user profile and the list of interest to a server for data collection;
means for transmitting information to the user in accordance with the user profile and interests;
means for compiling statistics based on the user profile and the list of interests; and
means for creating a plurality of libraries on different topics, said libraries created based on the compiled statistics.

42. The system of claim 41, further comprising means for monitoring usage habits of the user.

43. The system of claim 42, further comprising means for collecting data on the usage habits of the users, said data collected by the content recognition software after said monitoring.

44. A computer device comprising a computer readable medium having computer readable code means embodied therein for recognizing content, said computer readable code means further comprising:
means for collecting information from one or more business partners;
means for organizing the collected information into distinct categories;
means for receiving a search request from a user;
means for transmitting information to the user in accordance with the search request; and
means for updating statistics on user usage to reflect the search request by the user.

45. A computer device comprising a computer readable medium having computer readable code means embodied therein for recognizing content, said computer readable code means further comprising:
means for collecting information from one or more business partners;
means for organizing the collected information into distinct categories;
means for receiving a request from a user to access information on a selected topic;
means for making available information on the selected topic to the user; and
means for updating statistics on user usage to reflect the access information.

46. A computer device comprising a computer readable medium having computer readable code means embodied therein for recognizing content, said computer readable code means further comprising:
means for launching content recognition software on a personal computer;
means for receiving a user profile and a list of interests from a user;
means for transmitting the user profile and the list of interest to a server for data collection;
means for transmitting information to the user in accordance with the user profile and interests;
means for compiling statistics based on the user profile and the list of interests; and
means for creating a plurality of libraries on different topics, said libraries created based on the compiled statistics.

47. A method for providing content to a user, comprising:
launching content recognition software on a computer, wherein the content recognition software includes a data recognition algorithm that runs when the content recognition software is launched;
registering the content recognition software with a service provider;
transmitting a user profile to the service provider;
receiving information from the service provider in accordance with the user profile; and
selecting desired content from the received information.

48. The method of claim 47, wherein the service provider identifies the user based on said data recognition algorithm.

49. The method of claim 48, wherein the service provider logs a variety of data about user, including usage patterns of said user.

50. The method of claim 49, wherein all interactions between the user and the service provider are stored with the service provider.
